(19) United States
(12) Patent Application Publication
(10) Pub. No.: US 2019/0299092 A1
(43) Pub. Date: Oct. 3, 2019

(54) GAME APPARATUS, GAME SYSTEM, AND PROGRAM PRODUCT

(71) Applicant: BANDAI CO., LTD., Tokyo (JP)

(72) Inventors: Wataru HIGUCHI, Tokyo (JP); Reina FUKUOKA, Tokyo (JP); Yuki KADOTA, Tokyo (JP); Rokushi SUZUKI, Tokyo (JP); Mari KAKUWA, Tokyo (JP)

(73) Assignee: BANDAI CO., LTD., Tokyo (JP)

(21) Appl. No.: 16/363,369

(22) Filed: Mar. 25, 2019

(30) Foreign Application Priority Data
Mar. 30, 2018 (JP) 2018-067647

(51) Int. Cl. A63F 13/2145; A63F 13/79; A63F 13/69; A63F 13/45

(52) U.S. Cl. CPC A63F 13/2145; A63F 13/79; A63F 13/825; A63F 13/45; A63F 13/69

(57) ABSTRACT

There is provided a game apparatus executing a game based on game information obtained from an user item, including: a placement panel that allows a first-type user item and a second-type user item to be placed thereon; an obtaining unit that obtains the game information from an user item placed on the placement panel, a detection unit that detects a game operation performed while the game is being executed; a control unit that controls progress of the game on the basis of the obtained game information and the detected game operation, and a display unit that displays a screen concerning the game. The detection unit detects movement of the first-type user item on the placement panel as the game operation, and detects a moving operation for a item image associated with the second-type user item and displayed on the display unit as the game progresses as the game operation.

### CROSS REFERENCES TO RELATED APPLICATIONS

The present invention contains subject matter related to Japanese Patent Application No. 2018-067647 filed in the Japan Patent Office on Mar. 30, 2018, the entire contents of which are incorporated herein by reference.

### BACKGROUND OF THE INVENTION

### 1. Field of the Invention

The present invention relates to a game apparatus, a game system, and a program and relates specifically to an electronic game for which progress control is performed on the basis of information obtained from an item.

### 2. Description of the Related Art

A game apparatus is available that can provide an experience of playing a game in which, when a card is placed on a board surface, a game element associated with the card appears (Japanese Unexamined Patent Application Publication No. 2017-064314). This game apparatus is configured so that, when a moving operation for the card is performed on the board surface, a moving operation for the game element can be performed accordingly, and progress control for the game is performed in accordance with the moving operation.

Currently, game content that provides a play experience in game apparatuses is developed to not only provide games to other game cabinets or home game consoles but also increase users' interests in various ways by, for example, selling game items and goods provided in association with the games. Therefore, making the items that are concurrently developed usable in the game apparatuses leads to an increase in the attractiveness of the games.

Meanwhile, a 3D object, such as a figure, can be placed on the board. However, because of the form of the 3D object, a user may apply excessive force to the 3D object when placing the 3D object on the board surface or performing a moving operation for the 3D object. Further, the position of the center of gravity of the 3D object is different from that of cards, and the 3D object tends to be rolled over onto its side by a collision, etc. Accordingly, in a case of using the 3D object, a scratch may be made on the board surface, and the scratch may hinder moving operations for cards that are originally designed to be used in the game or may result in a decrease in the accuracy of recognizing the cards.

Specifically, for a game cabinet as described in Japanese Unexamined Patent Application Publication No. 2017-064314, during a game play, a user can perform a moving operation for an item without taking a look at their hand while watching a screen presented on a display unit that is different from the board surface. Therefore, handling a 3D object is highly likely to make the board surface deteriorate as described above.

### SUMMARY OF THE INVENTION

An object of the present invention is to provide a game apparatus, a game system, and a program that can provide an enjoyable play experience while increasing the attractiveness of a game.

A game apparatus according to an aspect of the present invention is a game apparatus executing a game based on game information obtained from an actual item, including a placement part, an obtaining unit, a detection unit, a control unit, and a display unit. The placement part is configured to allow a first-type actual item and a second-type actual item to be placed thereon. The obtaining unit obtains the game information from an actual item placed on the placement part. The detection unit detects a game operation performed while the game is being executed. The control unit controls progress of the game on the basis of the game information obtained by the obtaining unit and the game operation detected by the detection unit. The display unit displays a screen concerning the game. The detection unit detects, for the first-type actual item from which the game information is obtained, movement of the first-type actual item on the placement part as the game operation, and detects, for the second-type actual item from which the game information is obtained, a moving operation for a game element image associated with the second-type actual item and displayed on the display unit as the game progresses as the game operation.

With this configuration according to an aspect of the present invention, it is possible to provide an enjoyable play experience while increasing the attractiveness of a game.

### BRIEF DESCRIPTION OF THE DRAWINGS

FIG. 1 is a diagram illustrating an external appearance of a game apparatus according to an embodiment of the present invention;

FIG. 2 is a block diagram illustrating a functional configuration of the game apparatus according to the embodiment of the present invention;

FIGS. 3A to 3D are diagrams illustrating actual items usable in the game apparatus according to the embodiment of the present invention;

FIG. 4 is a diagram illustrating example screens that are displayed on a first display unit and a second display unit in a registration sequence in the game apparatus according to the embodiment of the present invention;

FIG. 5 is a diagram illustrating a virtual card presented in a game sequence in the game apparatus according to the embodiment of the present invention;

FIG. 6 is a flowchart illustrating a provision process performed in the game apparatus according to the embodiment of the present invention; and

FIGS. 7A to 7D are diagrams illustrating data structures of respective types of information used in the game apparatus according to the embodiment of the present invention.

### DESCRIPTION OF THE PREFERRED EMBODIMENTS

### Embodiment

Hereinafter, an exemplary embodiment of the present invention will be described in detail with reference to the drawings. Note that, in one embodiment described below, a description will be given of an example where the present invention is applied to a game apparatus that is configured so that information can be obtained from two different types of actual items (user items), the game apparatus being an example of a game apparatus according to the present invention. However, the present invention is applicable to any device that can obtain information from two or more different types of actual items.

A description is given herein under the assumption that “actual item” refers to an item that has a physical substance in the actual world, and “virtual item” refers to an electronic item that does not have a physical substance in the actual world but is handled as an item that is equivalent to an actual item in a program. It is assumed that a game that provides a play experience in the game apparatus of this embodiment progresses mainly in accordance with a moving operation for a card. In this embodiment, a card that is an actual item is referred to as an actual card, and electronic information handled as a card that is a virtual item (item image) is referred to as a virtual card. In a case where a card may represent both the actual and virtual cards or any of the actual and virtual cards, the card is described simply as “card” without “actual” or “virtual”. The prefix words “actual” and “virtual” are similarly used in a case where pieces of information corresponding to “actual” and “virtual” are managed while the pieces of information need to be distinguished from each other.

The description is given under the assumption that information can be obtained from the following two types of actual items in the game apparatus of this embodiment. One of the types is an actual card that is a first-type actual item according to the present invention, and is configured so that, when information is obtained from an actual card, it is possible to cause a game element (for example, a character) associated with the actual card to appear in the game executed in the game apparatus. The other type is a figure that is a second-type actual item according to the present invention, and is configured similarly to the actual card so that, when information is obtained from a figure, it is possible to cause a game element (similarly, a character) associated with the figure to appear in the game executed in the game apparatus. Among the types of actual items that are configured so that information can be obtained therefrom, the game apparatus is configured to be capable of providing an actual card (first-type actual item) and does not provide a figure (second-type actual item). A figure may be an item that is purchased from, for example, an item vending machine, such as a capsule vendor, or a shop and obtained, or may be an item for sales promotion that is provided, for example, by distribution at a storefront or as a supplement to an article for sale.

The description is given under the assumption that the two types of actual items are coded by converting respective pieces of information (game information) added thereto in different formats, and different obtainment processes are performed when the pieces of information are obtained from the respective types of actual items. In this embodiment, the description is given under the assumption that the pieces of information are added to the respective types of actual items as follows. That is, the pieces of game information are added by printing codes in different schemes on the surfaces of the respective types of actual items.

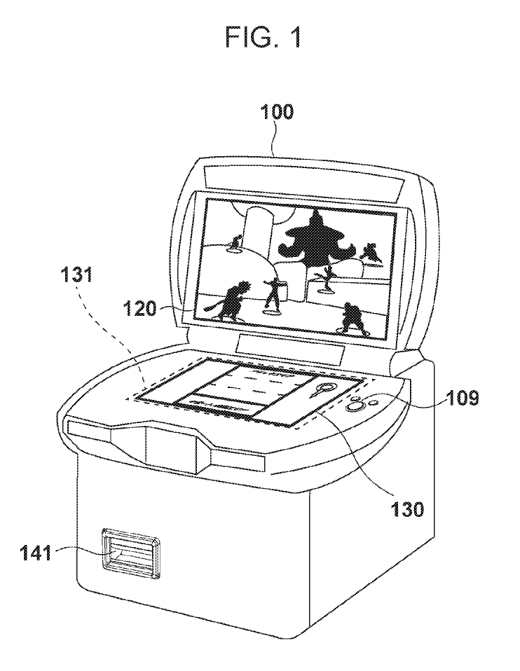

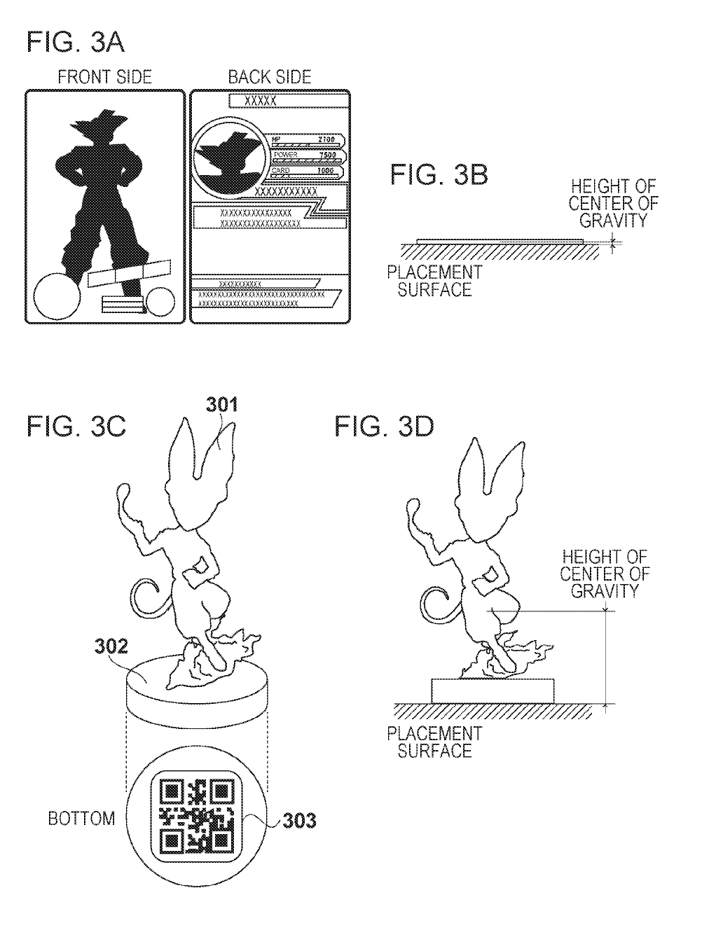

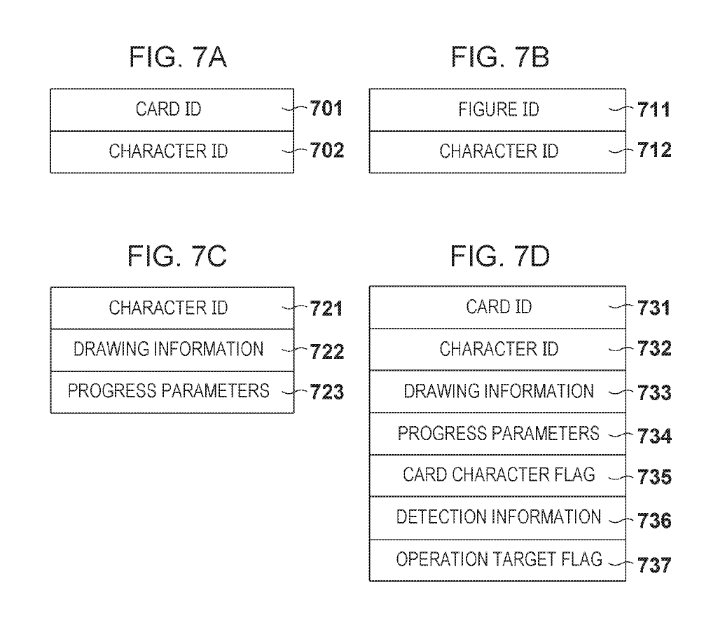

Game information is added to an actual card by printing a code obtained by converting the game information on at least one of the front side and the back side of the actual card. The game information added to an actual card includes, for example, a card ID 701 with which the actual card can be uniquely identified and a character ID 702 for uniquely identifying a character that is a game element associated with the actual card, as illustrated in FIG. 7A. As described below, a game apparatus 100 of this embodiment as illustrated in FIG. 1 is configured so that, when moving operations are performed for a plurality of actual cards on a placement panel 131, operations concerning the game can be input. Therefore, when a 2D code that is formed in a format with which at least one of the position, rotation, and movement can be easily detected with a small computational load and that serves as first identification information according to the present invention is printed on a side of an actual card, the game information is added to the actual card. An actual card is formed by printing a character image of a character that is associated with the actual card thereon so as to be visibly recognized, which provides an attractive aspect concerning collection of items of the game content. Therefore, in this embodiment, the code is printed on an actual card in an invisible ink, as illustrated in FIG. 3A, so as not to spoil the appearance of the item.

Meanwhile, game information is added to a figure in a similar manner to an actual card by attaching a code obtained by converting the game information to one of the surfaces of the figure using, for example, a sticker. In this embodiment, the game information attached to a figure includes a figure ID 711 with which the figure can be uniquely identified and a character ID 712 for uniquely identifying a character that is a game element associated with the figure, as illustrated in, for example, FIG. 7B. In the game apparatus 100 of this embodiment, information is obtained from a figure on the placement panel 131 in a similar manner to an actual card. If a form is employed in which, when a figure is moved on the placement panel 131 during a game play, an input operation concerning the game is accepted, as described above, the surface of the placement panel 131 may be scratched. Therefore, the game information needs to be obtained from a figure only before a game play, and obtainment of the game information need not be allowed during a game play. Therefore, unlike an actual card, the code attached to a figure need not be in a form with which the position of the figure and rotation or movement of the figure on the placement panel 131 can be easily detected, and a code that is based on a scheme different from the scheme of the code attached to an actual card and that serves as second identification information according to the present invention is employed as the code attached to a figure.

A figure is a 3D object having the external appearance of a character that is associated with the figure, as illustrated in, for example, FIG. 3C. If a sticker is affixed to a part (character statue part 301) of the object having the external appearance of a character, the appearance of the figure is spoiled. Therefore, a figure configured so that information can be obtained therefrom in the game apparatus 100 of this embodiment includes a base 302 that is connected to the lower part of the character statue part 301, and a sticker 303 is affixed to the bottom of the base 302, as illustrated in FIG. 3C. Therefore, in a case where such a figure is disposed to enjoy watching the figure, the bottom of the base 302 is not visible. Further, the code need not be configured so as to facilitate detection of movement on the placement panel 131 during a game play, and therefore, the code need not be printed in an invisible ink. Accordingly, costs for manufacturing the figure can be reduced.

Note that, in this embodiment, the description is given under the assumption that both a game element associated with an actual card and a game element associated with a figure are characters. However, the embodiment of the present invention is not limited to this. That is, game elements associated with an actual card and a figure may be things, effects that are produced, or other game elements, or different game elements may be associated with these different types of actual items.

In this embodiment, the description is given under the assumption that the first-type actual item provided by the game apparatus and the second-type actual item, which is the other type of actual item configured so that information can be obtained therefrom in the game apparatus, are an actual card and a figure, respectively. Differences between these actual items are not limited to the format of the code used to add game information. That is, the present invention is made so that the apparatus is used in such a manner that the placement panel 131 is easily maintained in a good condition while increasing attractiveness by making various actual items usable in the game. As long as the actual items are classified as follows, any actual items can be used.

The first-type actual item and the second-type actual item may be classified on the basis of whether each actual item is unlikely to roll over onto its side, that is, whether each actual item is unlikely to make a scratch on the placement panel 131 in a case where the actual item is placed on the placement panel 131 and the game is played. The first-type actual item is not limited to a card, and any actual item may be used as long as the actual item has a form with which the actual item can slide on the placement panel 131 without being rolled over onto its side by force applied to the upper surface of the actual item. Meanwhile, the second-type actual item is not limited to a figure, and any actual item that can be rolled over onto its side by force applied to the upper surface of the actual item when, for example, the actual item is placed on the placement panel 131 may be used as an equivalent to the second-type actual item.

In other words, as illustrated in FIGS. 3B and 3D, the first-type actual item and the second-type actual item may be classified on the basis of determination as to whether each actual item can roll over onto its side when the actual item is placed on the placement panel 131, the determination being based on the ratio between the ground contact area of the actual item and the height of the center of gravity of the actual item from the surface of the placement panel 131 (the height of the center of gravity from the placement surface). The height of the center of gravity of an item that is made of, for example, metal having a high specific gravity and is heavy in weight is low, and the possibility of the item rolling over onto its side is reduced. However, the possibility of an actual item making a scratch at the time of a slide depends on the difference in hardness between the material of the placement panel 131 and the material of the actual item. Therefore, the second-type actual item may be an actual item made of a material having a hardness higher than that of the material of the placement panel 131.

### Configuration of Game Apparatus 100

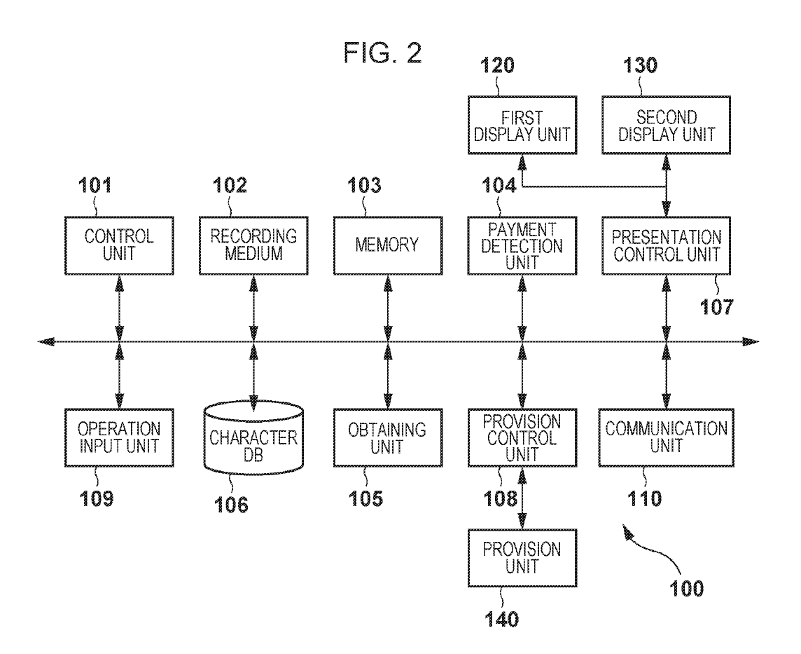

Now, the functional configuration of the game apparatus 100 according to the embodiment of the present invention having an external appearance as illustrated in FIG. 1 is described with reference to the block diagram in FIG. 2.

A control unit 101 is, for example, a central processing unit (CPU) (a computing device) and controls operations of the blocks of the game apparatus 100. Specifically, the control unit 101 reads an operation program, for the blocks, recorded to, for example, a recording medium 102, loads the operation program to a memory 103, and executes the operation program to thereby control operations of the blocks.

The recording medium 102 is a recording device, such as a nonvolatile memory or a hard disk drive (HDD), capable of retaining data in a substantially permanent manner. The recording medium 102 stores information about parameters, etc. necessary for operations of the blocks and various types of graphics data used in the game executed by the game apparatus 100 as well as the operation program for the blocks of the game apparatus 100. The recording medium 102 contains program instructions stored therein. Execution of the program instructions by the control unit 101 causes the game apparatus 100 to provide multiple functions, as explained below.

The memory 103 is a storage device, such as a volatile memory, used to temporarily store data. The memory 103 is used not only as an area for loading the operation program for the blocks but also as an area for temporarily storing data, etc. output as a result of operations of the blocks.

A payment detection unit 104 detects payment of a price in the game apparatus 100. Payment of a price may be determined by detecting, for example, coins of a specified amount or equivalent game tokens being dropped in a coin slot or completion of a payment process through communication with a chip for a specified amount of electronic money. The description is given under the assumption that the game apparatus 100 of this embodiment starts a service involving provision of an actual card to a user on the basis of payment of the price. However, payment of the price is not an essential requirement, and the service may be started in accordance with a predetermined start instruction.

A presentation control unit 107 controls presentation of various types of information to a user performed in the game apparatus 100. The description is given under the assumption that the game apparatus 100 of this embodiment includes a first display unit 120 and a second display unit 130 that display images (game screens, menu screens, etc.) as means for presenting various types of information to a user; however, the means for presenting information are not limited to these, and replacement or addition is allowed, as a matter of course.

The presentation control unit 107 includes a drawing device, such as a graphics processing unit (GPU), and performs a predetermined drawing process when generating screens to be displayed on the first display unit 120 and the second display unit 130. Specifically, the presentation control unit 107 performs appropriate arithmetic processing for a necessary drawing object on the basis of processing performed by or instructions given by the control unit 101 while the game apparatus 100 is operating (during a game play or in a standby state) to draw a screen. The generated screen is output to the first display unit 120 or the second display unit 130, which may be a display device included in the cabinet of the game apparatus 100 or eternally connected to the game apparatus 100 so as to be detachable and attachable, and is displayed within a predetermined display area so that the screen is presented to the user.

The game apparatus 100 of this embodiment displays a game screen. The game apparatus 100 includes two types of display devices (first display unit 120 and second display unit 130) as illustrated in FIG. 1, and the presentation control unit 107 generates game screens for the respective display devices. As illustrated in FIG. 1, the second display unit 130 in this embodiment includes, in an integrated manner, a board surface (placement panel 131) on which an actual card and a figure can be placed in a display area thereof. The placement panel 131 is configured so that an actual card and a figure can remain placed on the placement panel 131 concurrently in a registration sequence described below; however, only an actual card can be placed on the placement panel 131 in a game sequence. Therefore, in each of the sequences, detection of the presence of the actual items on the placement panel 131 is performed.

Note that the second display unit 130 of this embodiment is configured so that, while displaying a game screen that transitions from one to another, an obtaining unit 105 described below can obtain an invisible code attached to an actual card placed on the placement panel 131 and a visible code attached to a figure placed on the placement panel 131. For example, in a case where the second display unit 130 is a liquid crystal display device, the second display unit 130 needs to be formed such that a light transmission liquid crystal panel layer and a light guide layer are provided as lower layers of the placement panel 131, a light source is disposed around (on the side of) the light guide layer, and a casing that can be a shield is not provided on the bottom of the second display unit 130. Accordingly, an image capturing unit (not illustrated) included in the obtaining unit 105 can capture and obtain an image, from which the code of an item placed on the placement panel 131 can be extracted, on the back side of the second display unit 130 (from inside the cabinet of the game apparatus 100). Here, the image capturing unit may be configured to be capable of capturing images of both the code attached to an actual card in an invisible ink and the code attached to a figure, or the image capturing unit may be formed of two types of image capturing units capable of capturing images of the respective codes. The configuration of the second display unit 130 is not limited to this. Even if the second display unit 130 employs, for example, a rear projection scheme, the second display unit 130 can similarly capture an image from which the code of an item placed on the placement panel 131 can be extracted.

When a game that is provided by the game apparatus 100 of this embodiment in response to payment of a price is played, the obtaining unit 105 obtains pieces of information from actual cards and a figure placed on the placement panel 131, distinguishes the plurality of actual cards from each other, and detects at least one of the position, rotation, and movement of each actual card. The obtaining unit 105 includes the image capturing unit that, for example, captures an image on the back side of the second display unit 130 as described above, and applies a predetermined arithmetic operation to the image obtained by image capturing, thereby extracting and converting the code attached to the item to obtain game information. In this embodiment, different generation schemes are employed for the code attached to an actual card and the code attached to a figure, and therefore, the arithmetic operation used in extraction and conversion of the code attached to an actual card and the arithmetic operation used in extraction and conversion of the code attached to a figure are different. Note that, in this embodiment, the obtaining unit 105 is configured to be capable of capturing an image of the entire area of the placement panel 131 so as to be able to detect whether an actual card and a figure are placed on the placement panel 131.

A character database (DB) 106 is a database for managing information (character information) about each character that is specified in advance so as to appear in the game. In the game provided by the game apparatus 100 of this embodiment, a plurality of characters can appear during the game concerning a single game play. In a case where a user uses an actual card in the game play, the game apparatus 100 causes a character associated with the actual card to appear in the game as, for example, a use character of the user, and the user can use (operate) the use character.

The character information managed in the character DB 106 for each character may have a data structure as illustrated in, for example, FIG. 7C. As illustrated in FIG. 7C, the character information includes a character ID 721 for uniquely identifying the character, drawing information 722 that includes graphics data, etc. used in generation of a screen when the character is caused to appear in the game, and progress parameters 723 that describe the name, attributes, etc. of the character and the capacities specific to the element, such as predetermined physical strength (endurance), offensive strength, defensive strength, techniques to be used, special skills, etc., the drawing information 722 and the progress parameters 723 being association with the character ID 721. The progress parameters 723 include information that is referenced in the game in which the character is caused to appear, and the information is used to perform progress control for the provided game.

Note that, in this embodiment, the description is given under the assumption that graphics data is stored in the character DB 106 and the character information includes the graphics data; however, the embodiment of the present invention is not limited to this. The character information may include information indicating a place where the graphics data is stored.

In this embodiment, the description is given under the assumption that a character ID is associated with character information that is managed for each character in the character DB 106 and, on the basis of a character ID in game information obtained by the obtaining unit 105 from an actual card or a figure, various types of information necessary for progress control for the game concerning a character associated with the actual card or the figure is obtained from the character DB 106 to thereby enable registration of the character that is caused to appear in the game. However, the embodiment of the present invention is not limited to this. That is, game information attached to an actual card or a figure need not include only information, such as a character ID, for identifying character information and may include various types of information necessary for progress control for the game.

A provision control unit 108 performs control to usually provide one actual card per game play based on payment of a price. The actual card provided by the game apparatus 100 is provided, for example, before the start of a game sequence involving provision of a predetermined play (a game part in which an operation character is operated, i.e., a battle game). That is, the actual card is basically a card to which (fixed) information determined in advance for the card is attached regardless of the content of the game play. A provision unit 140 is, for example, a card dispenser and needs to be configured to include a stocker (not illustrated) for piling actual cards in the vertical direction and a mechanism for providing one actual card retained at the bottom of the stocker in response to a provision instruction given by the provision control unit 108. In a case where the provision unit 140 is built in the cabinet of the game apparatus 100, the provided actual card needs to be guided to an outlet port 141 (see FIG. 1) that is accessible from outside the game apparatus 100 and provided to the user. The actual cards provided by the game apparatus 100 of this embodiment are ready-made cards that are printed and manufactured in advance, and the design of a character image, parameters, etc. printed on the front side of each actual card are fixed.

Note that the description is given under the assumption that the game apparatus 100 of this embodiment provides ready-made cards that are printed in advance at, for example, a factory and issued and have the fixed design. However, the provided actual cards may be cards for which the design can be dynamically changed by on-demand printing. In this case, the provision unit 140 needs to be a printing device that performs printing on a predetermined paper medium, game information including a character ID of a character selected by a user or selected in a lottery process as the game progresses needs to be created, the game information needs to be converted to a code by using a conversion scheme for actual cards, and the obtained code needs to be printed on an actual card.

An operation input unit 109 is a user interface of the game apparatus 100 and includes, for example, an operation member for inputting a direction, an operation member for inputting a decision, and various sensors. When the operation input unit 109 detects an input operation performed for any operation member, the operation input unit 109 outputs a control signal corresponding to the input operation to the control unit 101. Note that, in this embodiment, the description is given under the assumption that the game apparatus 100 includes various interfaces as physical operation members; however, the game apparatus 100 may include, for example, a touch input detection sensor that detects a touch operation (touch input) with a human body performed on the screen of the second display unit 130, that is, on the placement panel 131.

A communication unit 110 is a communication interface with an external device of the game apparatus 100. The communication unit 110 is connected to the external device via a network (wired or wireless network), which may be a communication network such as the Internet, or a cable that connects devices to enable data transmission and reception. For example, the communication unit 110 converts information that is input as a transmission target to data in a predetermined format, and transmits the data to the external device via the network. For example, when receiving information from the external device via the network, the communication unit 110 decodes and stores the information in the memory 103.

### Flow of Play Experience Provided

Now, a flow of a play experience provided to a user in the game apparatus 100 of this embodiment is described. As described above, when a price for provision of a play experience is paid, the game apparatus 100 of this embodiment starts various processes concerning provision of a play experience, and a play experience is provided while transitions between the following sequences occur. Note that the provision unit 140 of this embodiment provides ready-made cards, and therefore, provides one actual card when provision of a play experience is started.

### Registration Sequence

When provision of a play experience is started on the basis of payment of a price and provision of an actual card is completed, the game apparatus 100 transitions to a state where a registration sequence is performed. The registration sequence is a sequence in which game information from an actual card and a figure can be obtained for registering characters (use characters) that are caused to appear in a battle game that is executed in a game sequence described below.

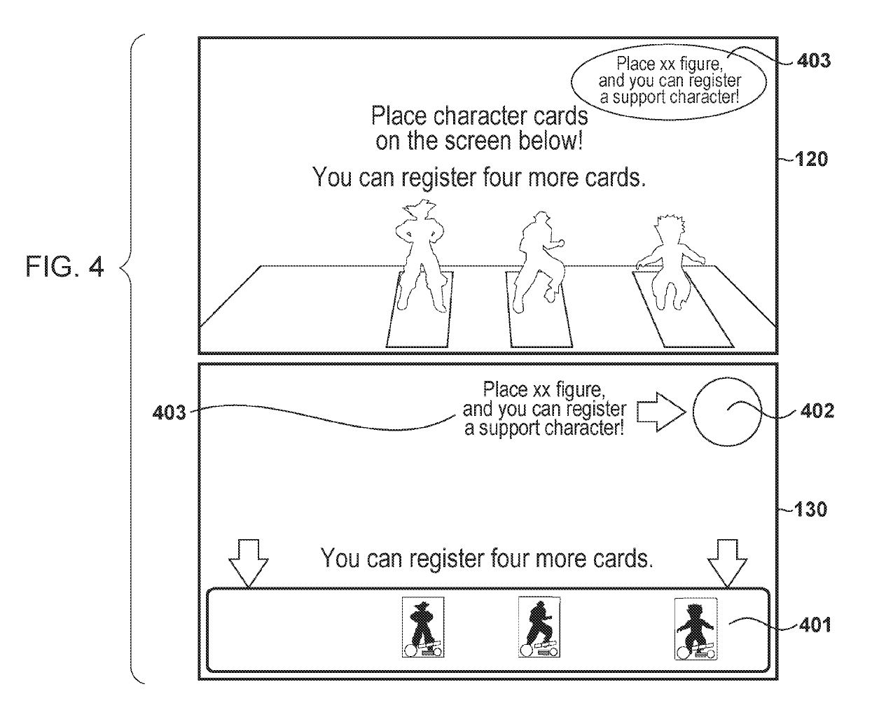

When a user places an actual card and a figure on the placement panel 131, the user can cause the obtaining unit 105 to obtain game information from these actual items and register characters associated with the actual items as use characters. In the game apparatus 100 of this embodiment, a position on the placement panel 131 at which game information is obtained in the registration sequence is made different between an actual card and a figure for the purpose of efficiently performing an arithmetic operation (image conversion, code detection, and decoding) for obtaining game information from a captured image. Therefore, in the registration sequence, screens each indicating areas in which game information is obtained from actual items are displayed on the first display unit 120 and the second display unit 130, as illustrated in, for example, FIG. 4.

In the example illustrated in FIG. 4, an area in which game information is obtained from an actual card for registering a use character is limited only to an area 401, which is an area closest to the user in the second display unit 130 or the placement panel 131. When the area in which information is obtained is limited as described above for actual cards, the user can register a use character while placing actual cards owned by the user in the other area, checking the actual cards, and planning a strategy for the game. Taking into consideration such a use form, the user may consider replacement of use characters when registering a use character using an actual card. Therefore, each time an actual card placed within the area 401 is replaced in the registration sequence, the control unit 101 performs registration and cancellation of use characters on the basis of game information obtained by the obtaining unit 105.

In the example illustrated in FIG. 4, an area in which game information is obtained from a figure for registering a use character is limited only to a top right area 402 in the second display unit 130 or the placement panel 131. Here, the figure is neither an actual item that is provided by the game apparatus 100 nor an item that needs to be used in a usual game play. Further, the user might not know that a game play using the figure is allowed. Therefore, as illustrated in FIG. 4, the screen displayed on the second display unit 130 in the registration sequence includes a message 403 indicating that the user can register a use character by causing information to be obtained from the figure. The message 403 is a message for the purpose of informing the user that the user can register a use character using a figure as described above. Therefore, after game information has been obtained once from a figure while one play experience is being provided, control may be performed so as to delete the message from the screen to avoid an impression of redundancy.

As the game in which a play experience is provided by the game apparatus 100 of this embodiment, a battle game including a battle with a human character is assumed. When a use character registered on the basis of a figure is handled equally to a use character registered on the basis of an actual card, the game may become imbalanced because possession of the figure differs depending on the user. Therefore, the game of this embodiment is configured such that use characters registered on the basis of up to seven actual cards are basically allowed to appear in the battle game and such that additional registration of a use character based on one figure is allowed. Here, the use character registered on the basis of the figure is handled as a support character so as to allow the use character to appear in the battle game only in a predetermined scene in the battle game.

In order to increase attractiveness, a plurality of types of figures that are configured so that information can be obtained therefrom may be provided in the game apparatus 100, and a scene in the battle game in which an associated character appears may be determined in accordance with the type of figure. The determination may be performed, for example, on the basis of information included and managed in corresponding character information or on the basis of a data string included in the figure ID 711. Information about a scene in which a use character registered on the basis of game information obtained from a figure appears need not be displayed in the registration sequence.

In a case of using a figure, the following are to be taken into consideration. The message 403 is presented, and therefore, it is unlikely that a figure is placed in an erroneous manner. Further, detection and obtainment of information can take a longer processing time than that for an actual card as described above. Therefore, in order to avoid an increase in the time of the provided experience, control is performed so that, unlike the case of an actual card, registration and cancellation of a use character is not allowed and so that changing of a use character registered on the basis of a figure is not allowed after the use character has been once registered.

The description is given under the assumption that the game of this embodiment progresses while transitions between a plurality of scenes occur and that control is performed so that a use character registered on the basis of a figure appears in a scene that appears while a game play is in progress and with which the use character is associated in advance. However, the embodiment of the present invention is not limited to this. For example, the scene in which the use character is caused to appear may be selected on the basis of an input operation performed by a user, a lottery process, etc. regardless of the use character. The term “scene” may represent a concept indicating a place (space) to which a character moves while the game is in progress or may be a concept indicating the progress state of the game, such as an advantageous state, an inferior state, or the state of a predetermined character.

### Game Sequence

When registration of use characters is completed in the registration sequence, the game apparatus 100 transitions to a state where a game sequence for implementing the battle game is performed.

In the game sequence, when the user performs a moving operation for an actual card placed on the placement panel 131 and corresponding to a use character, an action of the corresponding use character can be basically determined. That is, the control unit 101 performs progress control for the game on the basis of the moving operation performed on the placement panel 131 for the actual card corresponding to the use character.

As described above, the battle game progresses while transitions between a plurality of scenes occur. In a case where a use character that corresponds to a figure is present, when a transition to a scene that corresponds to the type of the use character occurs, the use character corresponding to the figure also becomes an operation target in addition to a use character corresponding to an actual card. Meanwhile, when the figure is placed on the placement panel 131 and a moving operation is performed, it is likely that the placement panel 131 is unintentionally scratched as described above. Therefore, in the game apparatus 100 of this embodiment, when the game progresses and the scene appears, a corresponding game element image is displayed on the second display unit 130 to accept a moving operation for the use character corresponding to the figure.

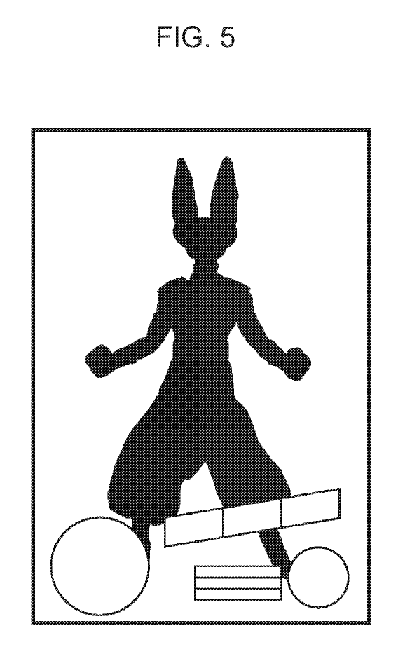

The game element image corresponding to the use character corresponding to the figure and displayed on the second display unit 130 includes an image of the use character corresponding to the figure, and is a card image having an external appearance so as to imitate an actual card, as illustrated in FIG. 5 in order to provide a sense of operation similar to that provided by an actual card corresponding to another use character. When the card image is controlled so that, when a touch operation is performed on the placement panel 131, a moving operation can be performed, it is possible to cause the card image to function as a virtual card that serves as a game input interface. That is, regarding a use character corresponding to a figure, when the game progresses and a predetermined scene for the use character appears, an associated virtual card is displayed on the second display unit 130, and a moving operation is performed for the virtual card by the user performing a touch operation for the virtual card. Accordingly, an action of the corresponding use character can be determined in a manner similar to a use character corresponding to an actual card.

### End Sequence

When an end condition for the battle game is satisfied in the game sequence, the game apparatus 100 transitions to a state where an end sequence is performed. In the end sequence, for example, the result of the played battle game is displayed, the ranking is communicated, and a message for prompting the user to allow the next user who wants to use the apparatus to take their turn is displayed. After the end sequence, the game apparatus 100 transitions to a state where a standby sequence in which payment of a price can be accepted is performed.

### Provision Process

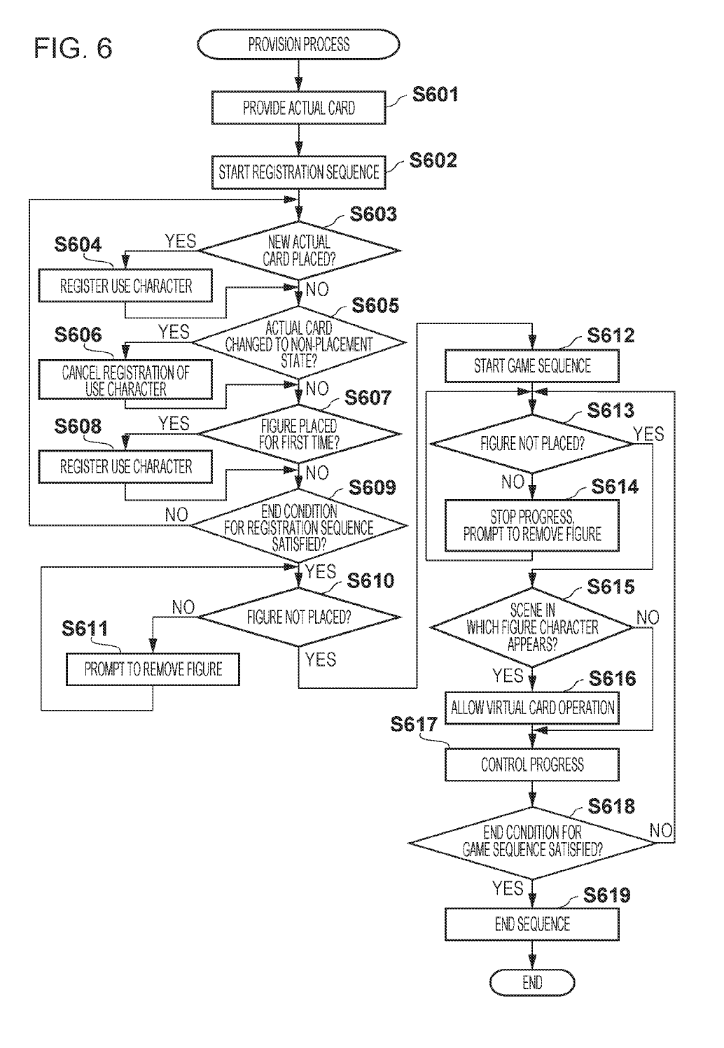

In the game apparatus 100 of this embodiment configured as described above, a provision process is performed to provide a play experience. The provision process is specifically described with reference to the flowchart in FIG. 6. The process corresponding to the flowchart can be implemented by the control unit 101 reading a corresponding processing program stored in, for example, the recording medium 102 and loading to the memory 103 and executing the processing program. It is assumed that, for example, the provision process is started when a price is paid, and the description is given. A description of display control associated with screen transitions concerning the sequences in the provision process will be omitted unless there are matters to be specially noted. It is assumed that, while a play experience is being provided, the presentation control unit 107 performs a necessary drawing process to generate screens to be displayed on the first display unit 120 and the second display unit 130.

In S601, in accordance with control by the control unit 101, the provision control unit 108 controls the provision unit 140 to provide one actual card.

In S602, the control unit 101 starts a process for the registration sequence. When a transition to the registration sequence occurs, in accordance with control by the control unit 101, the presentation control unit 107 performs a process for causing the second display unit 130 to display a board surface image for use character registration as illustrated in FIG. 4.

In S603, the control unit 101 determines whether a new actual card is placed in an area (card obtainment area) on the placement panel 131, the area corresponding to the area 401 in the board surface image. Determination in this step may be performed, for example, on the basis of whether the obtaining unit 105 detects the presence of a new code (for an actual card), from which game information has not been obtained, in an area in a captured image of the placement panel 131, the area corresponding to the card obtainment area. In a case where the control unit 101 determines that a new actual card is placed in the card obtainment area, the process proceeds to S604. In a case where the control unit 101 determines that a new actual card is not placed, the process proceeds to S605.

In S604, in accordance with control by the control unit 101, the obtaining unit 105 obtains game information from the new actual card placed in the card obtainment area. Specifically, the obtaining unit 105 performs a conversion process for the code detected from the captured image to obtain game information. When the game information is obtained, the control unit 101 adds, on the basis of the game information, information (use character information) about a use character to a use character table in the memory 103 to register the corresponding use character. More specifically, on the basis of the character ID 702 in the game information obtained from the new actual card, the control unit 101 obtains character information managed with the character ID from the character DB 106 and adds use character information to the use character table to register the use character.

As illustrated in, for example, FIG. 7D, use character information managed for each use character may include drawing information 733 and progress parameters 734 for the character, a card character flag 735 indicating whether the use character is registered on the basis of an actual card, detection information 736 indicating the current state of the corresponding actual card on the placement panel 131 (at least one of the position, rotation, and movement), and an operation target flag 737 indicating whether the character is in an operable state in the game sequence, these pieces of information being associated with a card ID 731 and a character ID 732 of the actual card. The card character flag 735 may be, for example, Boolean information, and it is assumed that “true” indicates that the use character is registered on the basis of game information obtained from an actual card and “false” indicates that the use character is registered on the basis of game information obtained from a figure. The detection information 736 is used in the game sequence, and therefore, information need not be added thereto in the registration sequence. The operation target flag 737 may be, for example, Boolean information, and “true” indicates that the character is in an operable state; however, the operation target flag 737 may be set to “false” during the registration sequence.

In S605, the control unit 101 determines whether any of the actual cards registered as use characters is made to enter a non-placement state in the card obtainment area. The non-placement state in the card obtainment area may indicate a state where any of the actual cards registered as use characters is removed from the placement panel 131 or may indicate a state where any of the actual cards registered as use characters is moved outside the card obtainment area. In a case where the control unit 101 determines that any of the actual cards registered as use characters is made to enter the non-placement state in the card obtainment area, the process proceeds to S606. In a case where the control unit 101 determines that none of the actual cards are made to enter the non-placement state, the process proceeds to S607.

In S606, the control unit 101 deletes use character information about the actual card that has been made to enter the non-placement state from the use character table to cancel registration as a use character.

In S607, the control unit 101 determines whether a figure is placed in an area (figure obtainment area) on the placement panel 131, the area corresponding to the area 402 in the board surface image, for the first time while the present play experience is being provided. Determination in this step may be performed on the basis of whether a use character corresponding to a figure has not been registered in the use character table and whether the obtaining unit 105 detects the presence of a code (for a figure), from which game information has not been obtained, in an area in a captured image of the placement panel 131, the area corresponding to the figure obtainment area. Determination as to whether a use character corresponding to a figure has been registered in the use character table needs to be performed by determining whether use character information in which the card character flag 735 is set to false is present. In a case where the control unit 101 determines that a figure is placed in the figure obtainment area, the process proceeds to S608. In a case where the control unit 101 determines that a figure is not placed in the figure obtainment area, the process proceeds to S609.

In S608, in accordance with control by the control unit 101, the obtaining unit 105 obtains game information from the figure placed in the figure obtainment area. When the game information is obtained, the control unit 101 adds, on the basis of the game information, use character information to the use character table. At this time, the figure ID 711 in the game information is set as the card ID 731 in the use character information, and the card character flag 735 is set to false. Note that movement detection on the placement panel 131 is not performed for a figure, and therefore, a detection result based on the actual item is not input as the detection information 736 in the use character information added in this step, which is also true for the game sequence. When a transition to a scene in which the use character is caused to appear occurs, position information that is changed in accordance with a touch operation for a corresponding virtual card is stored as the detection information 736 and referenced. The control unit 101 controls the presentation control unit 107 to remove the message 403 from the board surface image displayed thereafter.

In S609, the control unit 101 determines whether an end condition for the registration sequence is satisfied. The end condition for the registration sequence may be determined on the basis of, for example, whether the user performs an input operation for ending registration or whether a predetermined limited time for the registration sequence has passed. In a case where the control unit 101 determines that the end condition for the registration sequence is satisfied, the process proceeds to S610. In a case where the control unit 101 determines that the end condition for the registration sequence is not satisfied, the process returns to S603. Here, in a case where the end condition is satisfied but the number of use characters corresponding to actual cards does not reach a preset number, a process may be performed in which one or more characters that are lent for the present battle game are selected by, for example, a lottery process and information about the one or more characters is added to the use character table so that the number of use characters reaches the preset number. Although a detailed description of this process will be omitted, a lent character that is additionally registered is handled similarly to a use character corresponding to an actual card, and is presented in a form of a virtual card so that a moving operation can be performed with a touch operation in a similar manner to a character corresponding to a figure. Meanwhile, unlike a character corresponding to a figure, a lent character is handled similarly to a use character corresponding to an actual card, and therefore, no limitations are imposed on a scene in which a moving operation can be performed.

In S610, the control unit 101 determines a non-placement state, that is, determines whether a figure is not placed on the placement panel 131. In a case where the control unit 101 determines that a figure is not placed on the placement panel 131, the process proceeds to S612. In a case where the control unit 101 determines that a figure is placed on the placement panel 131, the process proceeds to S611.

In S611, the control unit 101 controls the presentation control unit 107 to present, on at least one of the first display unit 120 and the second display unit 130, a screen for prompting the user to remove the figure placed on the placement panel 131, and the process returns to S610. In a case where a transition to the game sequence occurs in the state where a figure is placed on the placement panel 131, the placement panel 131 may be scratched, as described above. Therefore, the control unit 101 performs control so that a transition to the game sequence does not occur, that is, the battle game is not started before the figure is removed.

In S612, the control unit 101 starts a process for the game sequence. When a transition to the game sequence occurs, the control unit 101 first changes the operation target flag 737 in a piece of use character information in which the card character flag 735 is set to true to true among pieces of use character information managed in the use character table. Then, the control unit 101 references the detection information 736 for a use character for which the operation target flag 737 is set to true, and starts progress control for the game. In other words, when the game sequence is started, a use character corresponding to an actual card becomes an operation target, a moving operation for the corresponding actual card on the placement panel 131 is detected, and progress control for the game is performed on the basis of the moving operation.

In S613, the control unit 101 determines the non-placement state, that is, determines whether a figure is not placed on the placement panel 131. In the game apparatus 100 of this embodiment, detection is performed to determine whether a figure is placed on the placement panel 131 at all times or regularly during the game sequence as in the determination concerning a transition from the registration sequence to the game sequence to avoid a situation where the placement panel 131 may be scratched. In a case where the control unit 101 determines that a figure is not placed on the placement panel 131, the process proceeds to S615. In a case where the control unit 101 determines that a figure is placed on the placement panel 131, the process proceeds to S614.

In S614, the control unit 101 stops the game from progressing, that is, stops the process for the game sequence. Then, the control unit 101 controls the presentation control unit 107 to present, on at least one of the first display unit 120 and the second display unit 130, the screen for prompting the user to remove the figure placed on the placement panel 131, as in S611, and the process returns to S613.

In S615, the control unit 101 determines whether the game progresses and reaches a state where a scene appears in which a use character corresponding to the figure is caused to appear. In a case where the control unit 101 determines that the game progresses and reaches the state where a scene appears in which a use character corresponding to the figure is caused to appear, the process proceeds to S616. In a case where the control unit 101 determines that the game does not reach the state, the process proceeds to S617. Note that, in a case where use character information concerning a figure is not present in the use character table, the control unit 101 need not perform the process in this step, and the process may proceed to S617.

In S616, the control unit 101 controls the presentation control unit 107 to display a virtual card of the use character corresponding to the figure on the second display unit 130 only in the present scene. At this time, the control unit 101 changes the operation target flag 737 in the corresponding use character information to true only in the present scene. Further, the control unit 101 performs control to change the display position of the virtual card on the basis of a touch operation. More specifically, when a touch operation for the display area of the virtual card is detected, the control unit 101 changes the detection information 736 for the use character on the basis of the touch operation, and the presentation control unit 107 changes the display position of the virtual card by referencing the detection information 736 when generating a screen for the second display unit 130.

In S617, the control unit 101 performs progress control for the game in accordance with a moving operation that is performed for at least either the actual cards or the virtual card.

In S618, the control unit 101 determines whether an end condition for the game sequence is satisfied. In a case where the control unit 101 determines that an end condition for the game sequence is satisfied, the process proceeds to S619. In a case where the control unit 101 determines that an end condition for the game sequence is not satisfied, the process returns to S613.

In S619, the control unit 101 performs a process for the end sequence. After the process has ended, the control unit 101 completes the provision process and causes the game apparatus 100 to transition to a state where the standby sequence is performed.

As described above, with the game apparatus of this embodiment, a game play using an actual card and a game element associated with a figure is enabled to thereby increase the attractiveness of the game. Concurrently, a moving operation for the game element is configured to be performed using not an actual item but a virtual item to thereby prevent the game apparatus 100 from deteriorating and the item detection performance from decreasing, and an enjoyable play experience can be provided.

### OTHER EMBODIMENTS

The present invention is not limited to the embodiment described above, and various modifications and alterations can be made without departing from the spirit and scope of the present invention. The game apparatus according to the present invention can be implemented as a program that causes one or more computers to function as the game apparatus. The program can be recorded to a computer-readable recording medium and provided or distributed, or the program can be provided or distributed via a telecommunication line.

What is claimed is:

1. A game apparatus executing a game based on game information obtained from a user item, comprising:
a display having a display area;
a placement panel having a placement surface configured to allow a first-type user item to be movably placed thereon, and a second-type user item different from the first-type user item to be placed thereon;
a computing device; and
a storage medium containing program instruction s stored therein, execution of which by the computing device causes the game device to provide the functions of:
an obtaining unit configured to obtain the game information attached to the first-type user item and/or the second-type user item that is placed on the placement panel;
a detection unit configured to obtain instructions for an operation of the game while the game is being executed, by a first detection or a second detection, the first detection being a result of detecting a movement of the first-type user item on the placement panel, the second detection being a result of detecting a movement of an item image, the item image being associated with the second-type user item, and being displayed on the display; and
a control unit configured to
generate the item image when the obtaining unit obtains the game information from the second-type user item, and
control an execution of the game, based on the game information obtained by the obtaining unit and the instructions detected by the detection unit.

2. The game apparatus according to claim 1, wherein
the obtaining unit obtains the game information from the second-type user item placed on the placement panel, and
after the game information has been obtained from the second-type user item, the control unit causes the display to movably display the item image, upon detecting of a first state in which the second-type user item is moved out from the placement panel.

3. The game apparatus according to claim 1, wherein
the obtaining unit obtains the game information from the second-type user item placed on the placement panel, and
the control unit controls an execution of the game by detection of a first state in which the second-type user item is moved out from the placement panel or a second state in which the second-type user item is placed on the placement panel.

4. The game apparatus according to claim 1, wherein the second-type user item is a three-dimensional (3D) object having an external appearance of a game character which a user plays in the game.

5. The game apparatus according to claim 1, wherein the first-type user item has a form with which, when the first-type user item is placed on the placement panel, the first-type user item is slidable, without rolling over onto a side by force applied to the first-type user to be slid.

6. The game apparatus according to claim 4, wherein
each of the first-type user item and the second-type user item has a contact surface that contacts the placement surface of the placement panel when being placed, and has a center of gravity at a predetermined height from the placement surface of the placement panel, and
the first-type user item and the second-type user item differ in a ratio between an area size of the ground contact surface and the predetermined height of the center of gravity from the placement surface of the placement panel.

7. The game apparatus according to claim 4, wherein
the obtaining unit
obtains, the game information from first identification information in a first format, attached to the first-type user item, and
obtains the game information from second identification information in a second format different from the first format, attached to the second-type user item.

8. The game apparatus according to claim 7, wherein
the second-type user item further includes a base part to which the second identification information is attached, and onto which the 3D object is connected.

9. The game apparatus according to claim 1, wherein the placement panel and the display are integrally formed.

10. The game apparatus according to claim 9, wherein the detection unit includes a detection area that detects the movement of the item image, the detection area overlapping the display area of the display, the detection unit including a touch sensor configured to detect a touch by the user on the placement surface of the placement panel, and detecting the touch by the touch sensor as the movement of the item image.

11. The game apparatus according to claim 10, wherein the item image includes an image of a game character associated with the game information attached to the second-type user item, and has an external appearance of a virtual item that imitates the first-type user item.

12. The game apparatus according to claim 1, further comprising
an output unit configured to output a provision item of a same type as the first-type user item, wherein
the control unit controls the output unit to provide the user with the provision item upon a price being paid.

13. The game apparatus according to claim 1, wherein the obtaining unit obtains the game information from the first-type user item upon detection of the first-type user item being placed at a first position on the placement panel.

14. The game apparatus according to claim 13, wherein the obtaining unit obtains the game information from the second-type user item upon detection of the second-type user item being placed at a second position different from the first position on the placement panel.

15. The game apparatus according to claim 13, wherein
the control unit controls the display to
display a message indicating that obtainment of the game information from the second-type user item is possible before the obtaining unit obtains the game information, and
hide the message after the obtaining unit has obtained the game information.

16. The game apparatus according to claim 1, further comprising
a registration unit configured to register a game character to be shown in the game, associated with the game information obtained from the first-type user item or the second-type user item, wherein
in a case where the game information is obtained from the first-type user item, upon detection of the first-type user item being moved out from the placement panel, the control unit cancels the registration of the game character, and
in a case where the game information is obtained from the second-type user item, the control unit continues the registration of the game character associated with the second-type user item, after detection of the second-type user item being moved out from the placement panel.

17. The game apparatus according to claim 1, wherein
the second-type user item is selected from a kit of a plurality of types,
the game goes through a plurality of scenes, and
in a case where the game goes into a scene that corresponds to a selected one of the types of the second-type user item from which the game information is obtained appears, the control unit controls the display to display the item image of the game character associated with the second-type user item.

18. The game apparatus according to claim 16, wherein
the game progresses through a plurality of scenes, and
the game apparatus further comprises
a selector configured to select one among a plurality of scenes in which the item image of the game character, associated with the second-type user item from which the game information is obtained, is displayed.

19. A game system comprising:
a first-type user item;
a second-type user item; and
the game apparatus according to claim 1.

20. A computing program product for a game apparatus, the game apparatus executing a game based on game information obtained from a user item, including a display, a placement panel having a placement surface configured to allow a first-type user item to be movably placed thereon, and a second-type user item different from the first-type user item to be placed thereon, and a computing device to execute program instructions, the computer program product comprising:
program instructions to obtain the game information attached to the first-type user item and/or the second-type user item that is placed on the placement panel;
program instructions to obtain instructions for an operation of the game while the game is being executed, by a first detection or a second detection, the first detection being a result of detecting a movement of the first-type user item on the placement panel, the second detection being a result of detecting a movement of an item image, the item image being associated with the second-type user item, and being displayed on the display;
program instructions to generate the item image when the obtaining unit obtains the game information from the second-type user item; and
program instructions to control an execution of the game, based on the game information obtained by the obtaining unit and the instructions detected by the detection unit.
